(19) United States
(12) Patent Application Publication
(10) Pub. No.: US 2004/0253175 A1
(43) Pub. Date: Dec. 16, 2004

(54) Electrostatically enhanced tribochemical methods and apparatus

(76) Inventor: Donald R. Stiffler, Tempe, AZ (US)

Correspondence Address: Intellectual Property Department, DEWITT ROSS & STEVENS, S.C., Firstar Financial Centre, 8000 Excelsior drive Suite 401, Madison, WI, 53717-1914, US

(21) Appl. No.: 10/225,388

(22) Filed: Aug. 21, 2002

(51) Int. Cl. C01G 49/06; A62D 3/00

(52) U.S. Cl. 423/633; 423/659

(57) ABSTRACT

A milling apparatus is modified by electrically insulating the milling chamber to enhance the efficiency of tribochemical reactions between reactive compositions during milling. The enhanced level of tribochemical reactivity is attributed to the buildup of electrostatic charge in and on the milled chamber during mill operation. The insulated mills in accordance with the invention can be used in a wide variety of commercial applications generally involving tribomechanically induced redox chemistry, including ore extraction, precious metal extraction, production of ferrites and pigments, and waste processing.

### FIELD OF THE INVENTION

This invention relates to tribochemical methods and modified mills for carrying out such reactions. More particularly, this invention is directed to electrostatically enhanced tribochemical reactions affected by milling in insulated mills. The method and apparatus enable chemical reactions in a wide variety of commercially significant applications generally involving redox reactions. These applications include general ore extraction, precious metals extraction, production of ferrites and pigments, and waste processing.

### DESCRIPTION OF THE PRIOR ART

Currently there are no uniformly accepted models for tribochemical reactions. Some scientists accept the view that tribochemical processes are non-equilibrium reactions, and therefore tribochemical films produced during the sliding/abrasive contact of hard surfaces are non-equilibrium products of chemical reactions. Others believe that the contact between surfaces stimulates reaction by mechanical deformations at the atomic and microscopic levels, thereby speeding reaction rates at low temperatures. It has been proposed that when thin layers wear slowly in reactive gases, the defects generated will enhance the reaction rate sufficiently to form thermochemically stable products. Most tribochemical studies have been carried out with focus on the development of methods for designing surface materials for low friction and minimal wear.

In all fields of science and technology, one encounters processes by which mechanical energy is converted into other forms of energy. In some processes this conversion is an undesirable side effect and attempts are made to limit the loss of energy as much as possible. Thus, for example, loss of energy through the heat generated by the friction of moving machinery pieces and cutting procedures is minimized by application of lubricants to gliding surfaces and coolants in cutting procedures. On the other hand, there are many processes by which an intense interaction between moving parts and the ensuing conversion to other forms of energy is desired. The broad field of tribochemical activation of parts to increase chemical reaction potential belongs to the second group.

For the completion of chemical reaction between masses of reactants high amounts of activation energy are often required. Thus, for example, reactions of many substances with oxygen can only occur at temperatures for above 100° C. even though the free energy of the oxidation reaction at room temperature possesses high negative values. The activation energy necessary for most reactions is introduced into the chemical system in the form of thermal or electrical energy. It has, however, long been known that chemical reactions can also be initiated or accelerated by the introduction of mechanical energy in the form of impact, friction, and shock. Flint has been used to light fires since prehistoric times. Similarly matches and lighters each involve the use of chemical reactions initiated through frictional heating.

Tribochemistry is an area of chemistry which concerns itself with the chemical and physical changes in solid bodies, liquids, or gas that are under the influence of mechanical energy. In the field of tribochemistry there has been significant research and development effort to expand on its applications. There have been many reports in the technical literature on the use of tribomechanical/tribochemical activation to impart enhanced functionality. Thus it has been known that the strength of concrete is greatly increased by the swing mill grinding of concrete allowing reduction in the amount of cement needed and a reduction in the thermal treatment of finished concrete pieces. Further it has been shown that solids ground in different mills to the same size can exhibit extremely different physical and chemical characteristics. The use of tribochemical methods for producing modified surfaces is described in the patent literature. DeKoven et al., U.S. Pat. No. 5,073,461, describes a tribochemical method of producing an oxidized surface on a ceramic or metal-ceramic. Ninham et al., U.S. Pat. No. 5,466,310, describes the production of a nitride of a metal or solid metalloid by ball milling a powder of the metal in a nitrogen or nitrogen-containing atmosphere such as ammonia. The ball mill temperature ranges from room temperature to 500° C., more preferably from 200° C. to 400° C. and the gas pressure in the ball mill was typically about 300 kPa. Ball milling the metal or metalloid powder with an organic nitrogen-containing chemical yields a mixture of the nitride and carbide of a metal or solid metalloid.

### SUMMARY OF THE INVENTION

The present invention is directed toward improving the milling apparatus for conducting tribochemical reactions and in carrying out a wide variety of commercially significant tribochemical processes.

In one embodiment of the invention there is a milling apparatus that has a mill chamber for receiving chemical compositions to be milled and is modified to electrically insulate the mill chamber above ground potential. The chamber has an inner surface that is a dialectic material and it also contains a number of milling elements. The apparatus further includes a mounting frame for supporting the mill chamber for rotational, orbital or reciprocal movement relative to the said mounting frame. A motor is used for delivering the mechanical energy to move the mill chamber. The chamber can be further modified to include a valve port for delivering or venting fluids and gases from the chamber, a temperature sensor, a controller and/or a means for monitoring and controlling electrostatic charge on the outer surface of the mill during operation. The milling apparatus can be in the form of a ball mill, rod mill, swing mill, or other general milling machine.

The modified mill of this invention is used for carrying out tribochemical reaction of chemical reactants during the milling process. Typically the tribochemical reaction comprises at least one redox reaction and the reactants can optionally include a fluid or gas capable of reacting with solid reactants during the mill operation.

In another embodiment, the modified milling apparatus is used to effect tribochemical reaction of a substantially water insoluble ore comprising a metal species with an ore modifying agent, typically a reducing agent. During mill operation, at least a portion of the water insoluble ore is chemically converted to a more water soluble form of the water species. The soluble metal species, typically a soluble salt form, is isolated by washing the milled reactants to form a solution of water-soluble metal salts. The solution can then be processed to produce a resultant product concentrated in one or more of the metal species of the ore.

In another embodiment, the modified milling apparatus is used to react an ore with a reducing agent to effect reduction of at least part of the ore.

In another embodiment, the modified milling apparatus is used to react an ore with an oxidizing agent to effect oxidation of at least part of the ore.

In another embodiment, the modified milling apparatus is used to grind and react components of a mineral glass produced from plasma fusion treatment of a mineral ore containing various rare earth metals. During the mill operation, the milling surfaces become impregnated with one or more of the rare earth metal species which can be recovered by chemical or mechanical processing.

The objects and advantages of the invention will appear more fully from the following detailed description of the preferred embodiment of the invention made in conjunction with the accompanying drawings.

### BRIEF DESCRIPTION OF THE DRAWINGS

FIG. 1 is a schematic representation of a ball mill having an electrically insulated chamber in accordance with the invention.

FIG. 2 is similar to FIG. 1 showing the detail of the insulated mill chamber.

FIGS. 3A, 3B and 3C are similar to FIG. 2 illustrating details of an optional embodiment of the invention.

FIG. 4 is an X-Ray Diffractometry (XRD) scan of ferric oxide.

FIG. 5 is an XRD scan of ferrite.

FIG. 6 is an XRD scan of magnetite.

FIG. 7 is an XRD scan of product from the milling of iron ore with carbon in a padded mill.

FIG. 8 is an XRD scan of product from milling of iron ore with carbon in a hexagon padded mill.

### DETAILED DESCRIPTION OF THE INVENTION

The present invention provides an improved milling apparatus for carrying out tribochemical reactions between solid reactants or between solid reactants and fluid reactants, including gases and liquids. While the following detailed description of the invention focuses on the use of a modified ball mill apparatus, it will be appreciated that prior art recognized milling devices, including rod mills and swing mills alone or coupled in series to other milling devices, can be modified and utilized to carry out tribochemical reactions with enhanced efficiency and yield in accordance with this invention.

The present invention is based in part on the discovery that certain tribochemical reactions appear to proceed with greater efficiency under certain milling conditions, i.e., when the mill chamber is insulated from ground so that during mill operation a static charge is built up and maintained on the outer shell of the mill chamber. The mill chamber is typically supported for rotational, orbital or reciprocal movement allowing delivery of mechanical and kinetic energy to the mill chamber and the milling surfaces inside the chamber. The mill chamber is electrically insulated from its support/structure and from a motor used for delivering mechanical/kinetic energy to the milling surfaces. So insulated, it has been found that a significant electrostatic charge is accumulated on the surface of the chamber during mill operation. While the mode of action is not fully understood, empirically it has been found that the build up of electrostatic charge on the chamber during mill operation (when the chamber is electrically insulated) works to enhance the rate and efficiency of tribochemical conversion of reactants in the mill.

Thus, in accordance with one embodiment of the invention, there is an improved milling apparatus modified for carrying out tribochemical reactions. The milling apparatus can be in the form of any one of a wide variety of art-recognized and commercially available mills modified in accordance with this invention to provide an electrically insulated mill chamber. Thus, the mill can be in the form of a rod mill, a ball mill, a swing mill, and modified versions thereof alone or in series with other milling devices. Examples of mills that can be modified in accordance with the present invention are those described in U.S. Pat. Nos. 4,664,321; 4,289,279; 4,406,414; 5,383,615, 5,551,639; 5,246,173; 5,597,126; and 4,703,896, the disclosures of which are expressly incorporated herein by reference.

The milling apparatus includes a mounting frame for supporting a mill chamber for rotation, orbital or reciprocal movement relative to the said mounting frame. A motor is used for delivering mechanical energy to move the mill chamber and thereby impart mechanical and kinetic energy to the milling elements inside the chamber.

The present milling apparatus comprises a mill chamber for containing compositions/reactants to be milled in the apparatus. The chamber has an outer shell, usually of metal construction, and an inner surface typically of a dielectric composition. The chamber, when ready for operation, contains a number of milling elements, for example rods or balls for contacting and grinding the reactant compositions to induce tribomechanical reaction during the milling process. The milling elements are typically selected from metals, metal alloys and metal ceramics. Surface hardness of such milling elements can vary over a wide range, typically between about 40 to 70 on the Rockwell scale. The surfaces of the milling elements can be in the form of a metal, a metal alloy, or a ceramic. Examples of materials which can be used for the milling elements and/or the milling element surfaces in the apparatus of this invention are iron, nickel, cobalt, alloys thereof, boron carbide, aluminum oxide, silicon carbide, silicon nitride, titanium carbide, titanium nitride, tungsten carbide, tantalum nitride, and zircon ceramics.

The inner surface of the chamber is preferably coated or lined with a dielectric, non-conducting material such as rubber, neoprene, nylon, or butadiene-derived composition, or any other insulating material that has the necessary physical and chemical properties to withstand the abrasive conditions in the operating mill. Alternatively, the lining of mill chamber can be formed from other dielectric materials such as mineral or ceramic materials alone or more preferably from polymer-based liners using mineral or ceramic materials as a filler.

The mill chamber in ball mills and rod mills also typically includes one or more bars for imparting mechanical and kinetic energy to the milling elements and the reactants during the milling process. Preferably, the throw bars in the improved mill of the present invention are likewise constructed of dielectric materials having the requisite physical and chemical properties to withstand the conditions inside the chamber during mill operation.

The outer shell of the mill chamber can be constructed out of a wide variety of materials having the requisite physical properties for containing the milling elements and the reactant compositions during the milling process. Most typically, the mill chamber includes a port for loading and unloading the reactant compositions and milling elements from the mill chamber. The port is preferably fitted with a removable or hinged port cover or closure that can be locked into place to close and optionally seal the port during the mill operation. The chamber can be fitted with a valve for delivering or removing fluids from the chamber. In one embodiment of the invention, a valve is located on the outer shell of the chamber or at the terminus of a journal axially supporting the chamber in which case the journal includes an axially oriented passageway or conduit in fluid communication with the inside of the chamber and the valve. The valve at the terminus of the journal can be pivotally mounted to allow rotation of the journal and mill chamber independent of the valve. The valve can be used for purging and filling the chamber with an inert gas such as argon. It can also be used to deliver reactive gas such as oxygen, nitrogen oxides, ammonia, hydrogen sulfide, sulfur dioxide, ozone, low molecular weight olefins and the like, or liquid reagents before or during mill operation. Likewise, when the tribochemical reaction during the milling operation generates at least one fluid product, the valve can also be used to vent the mill to a fluid collection device.

In one embodiment, the mill chamber is fitted with a thermocouple or other sensor for providing signals indicative of the temperature of the reactant composition in the mill chamber during mill operation. The sensor can be in the form of a thermocouple mounted on the outer shell of the chamber and optionally battery operated. Further, the mill chamber can be constructed to include a heating element, usually, but not necessarily, as a part of one or more of the throw bars to heat reactant compositions in the mill chamber and a controller for the heating element that is responsive to signals received from the temperature sensor.

In yet another embodiment of the invention, the improved milling apparatus includes a monitor/controller for measuring and optionally controlling electrostatic charge on the outer shell of the mill chamber during mill operation. An electrically conducting strip or brush can contact the outer surface of the mill during mill operation and be electrically connected to a variable AC or DC voltage source to bias the mill chamber above or below ground. The same electrical contact can also connect a voltmeter for monitoring and optionally recording values of the electrostatic charge that builds up on the chamber during mill operation. Either the same or a second brush or strip electrode can contact the outer surface of the chamber and be connected to a static charge generator for increasing or decreasing the electrostatic charge on the outer shell of the mill chamber during mill operation. The electrostatic potential of the mill chamber during mill operation can range up to about 180 volts DC, more typically from about 0.5 to 70 volts DC, and up to about 180 volts AC. The electromagnetic frequency generated during mill operation, as measured by a capacitor coupled frequency counter, can range from 1 to 680 MHz.

The buildup of static electrical charge on the mill chamber has been associated with the enhanced rate and efficiency of performance of tribochemical reactions between reactive components of the composition being milled. Accordingly, a preferred feature of the modified mill, in accordance with the present invention, comprises an insulating element positioned to electrically insulate the mill chamber above ground potential during mill operation. The construction of the milling apparatus should be such that the mounting frame supporting the mill chamber and any connecting elements used for delivering mechanical energy to the mill chamber include insulating elements to electrically isolate/insulate the mill chamber above ground potential. This can be accomplished by any number of art-recognized techniques such as the use of connectors coated or formed with dielectric materials, e.g. polymers or ceramics, and/or using dielectric spacers or plates to separate the conductive surfaces of the mill chamber from other surfaces on the mill capable of carrying electrostatic charge to ground. Such modification to existing commercially available milling devices can be carried out using art-recognized engineering designs, concepts, and materials.

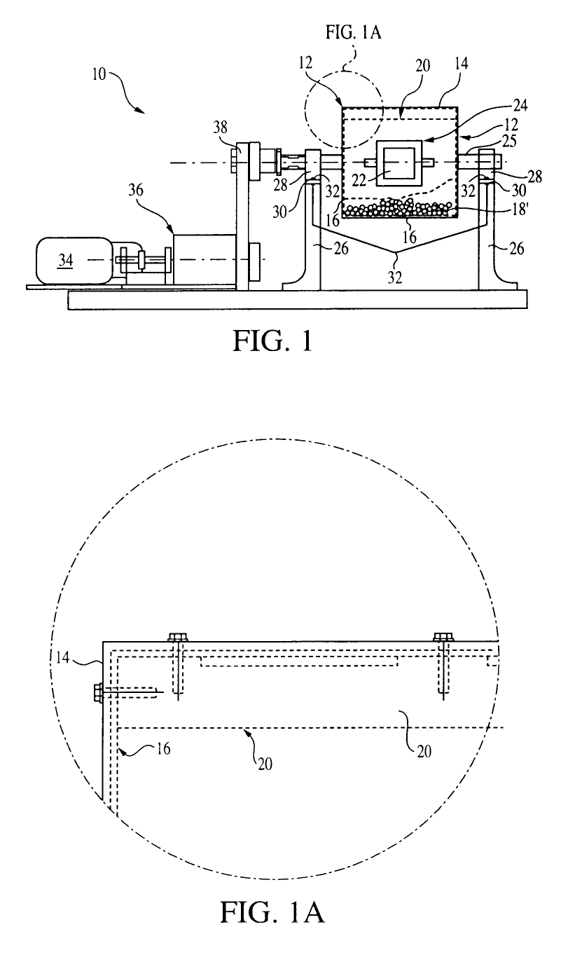

With reference to FIG. 1 there is illustrated a modified ball mill (10) in accordance with this invention. Ball mill (10) includes a mill chamber (12) for containing reactant compositions to be milled and milling elements (18). The mill chamber (12) includes an outer shell (14) having an inner surface comprising a dielectric layer (16) (e.g. neoprene or rubber) and a group of milling elements (18) in the form of steel or steel alloy balls or rods having a diameter ranging from about 1% to about 17%, more typically from about 3% to 8% of the diameter of the mill chamber. The milling elements can be of uniform size and mass or they can be of varying size and mass. The mill chamber also includes nylon throw bars (20), a chamber access port (22) and a cover/closure (24) for sealing the port (22) to prevent escape of milling elements (18) and milled reactant compositions from the chamber (12) during operation of mill (10). The chamber (12) is supported for rotational movement with a journal (25) on the mounting frame (26) and uses bearings (28) insulated from the frame (26) by nylon insulating elements (30). The chamber is held in place by insulated pillow block bolts (32). A motor (34) is used for delivering mechanical energy to the mill chamber (12) through a gear reduction unit (36) and a belt drive (38).

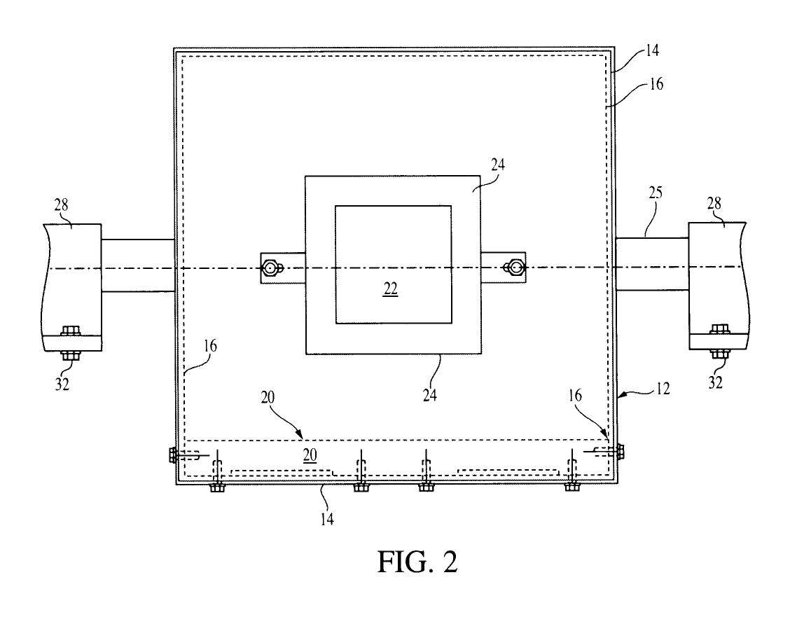

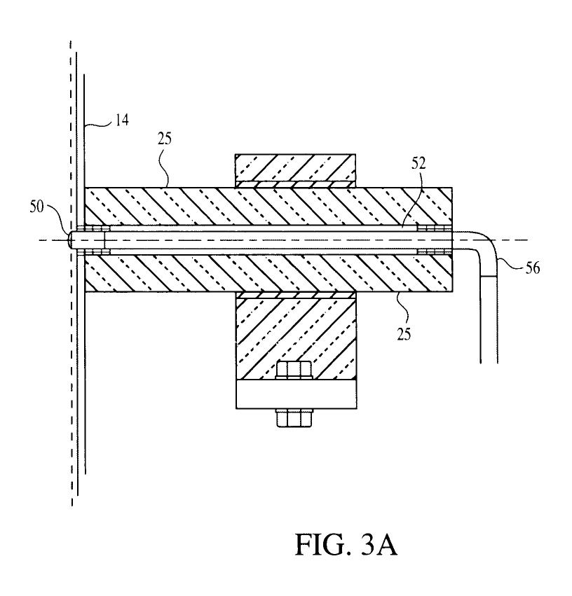

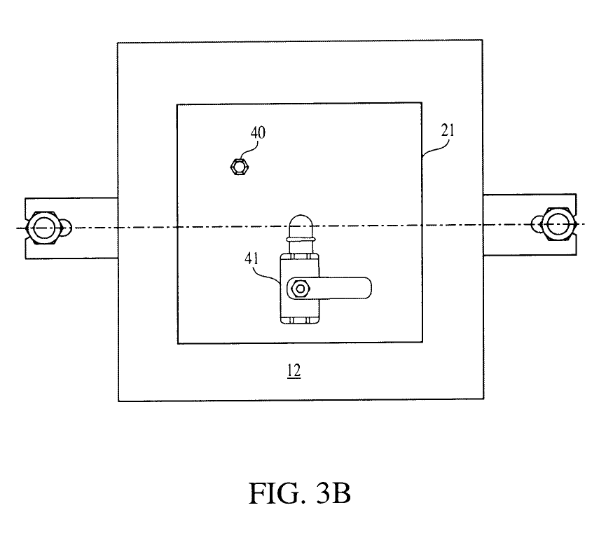

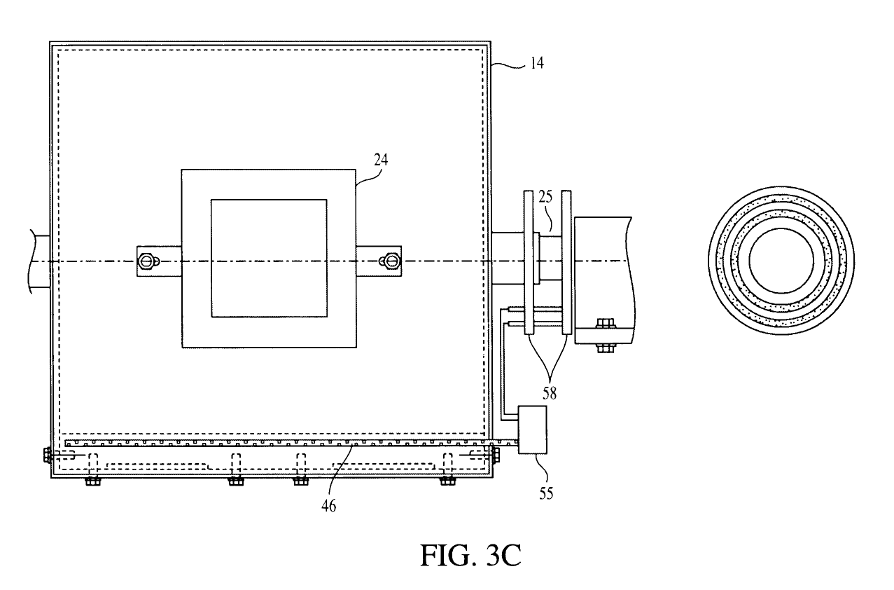

With reference to FIGS. 3A-3C, the ball mill can be further modified to have optional features not shown in FIGS. 1 and 2. With reference to FIG. 3B, the outer shell 14 can be fitted with an input valve (40) and a purge valve (41), optionally located on cover/closure (24), for delivering or removing fluids from mill chamber (12). Thus, for example, the mill chamber (12) can be purged with an inert gas to minimize atmospheric oxygen interference with the reaction conditions in mill (10). With reference to FIG. 3A a thermocouple (50) is located in axial passageway (52) through journal (25) to contact material in the mill chamber (12) during mill operation and it is in electrical communication with the temperature monitor (not shown) via insulated conduit (56). Alternatively, the thermocouple can be mounted on the outer shell of the mill chamber for sensing and providing signals indicative of the internal temperature in the mill chamber (12) during operation. Alternatively, or in addition, axial passageway (52) can be used for visual observation/monitoring of the milling activity in the chamber, e.g. through a fiber optic lens located in passageway (52). A thermocouple (50) can be interfaced with a controller for a heating element 46 (see FIG. 3C) positioned for delivering thermal energy to compositions and milling elements in mill chamber (12). A heating element (56) and controller (55) are powered via insulated power transfer rings (58).

Another optional modification of the invention is useful for monitoring and optionally controlling static charge buildup on the outer shell (14) of the chamber (12) during mill operation. An electrically conductive brush or strip electrode (not shown) can contact the outer shell of the mill chamber (12) and be electrically connected to an electrostatic potential monitor (not shown) and/or an electrostatic generator (not shown) for optionally controlling electrostatic charge on the outer shell (14) of mill (10) during mill operation.

In accordance with another embodiment of the present invention, the modified milling apparatus is used for carrying out tribochemical reactions of tribochemically reactive species. The reactants can be in solid or fluid form. They are combined in the electrically insulated mill chamber with milling elements such as balls or rods adapted for forceful abrasive or impact contact in the presence of the reactants during mill operation. The tribochemical process is carried out simply by operating the mill for a period of time sufficient to effect at least partial chemical reaction of the reactants. The reactants can be selected from a wide variety of solid, liquid, or gaseous materials including art-recognized reducing agents (e.g. carbon) or mild oxidizing agents (e.g. oxygen) that are induced to react with one another, typically via a redox (oxidation-reduction) mechanism to effect commercially significant chemical conversions in the mill. A catalyst (e.g. manganese dioxide) may be used to initiate the reaction between the mill reactants during the milling operation so as to effect a higher conversion percentage of the reactants to the final product.

In one example usage of the invention, the reactants include a substantially water insoluble ore with a metal species and an ore reducing agent.

Under the influence of the tribomechanical/tribochemical interactions during mill operation, at least a portion of the water insoluble ore is converted to a more water soluble form of the metal species. The mill-reacted ore is then processed by being washed with water, optionally at elevated temperatures, to form a solution of water-soluble metal salts. The solution is then processed, for example by precipitating the dissolved metal species, to produce a resultant product concentrated in the said metal species.

Any of the wide variety of ore minerals can be subjected to such processing to produce resultant products concentrated in one or more of the metal species present in the ore mineral. The ore can be processed using oxidation or reduction. When an oxidation process is chosen, the oxidizing agent may generally be oxygen based, e.g. the oxygen in ordinary air. When a reduction process is chosen, the reducing agent is typically a carbon-based compound or composition, e.g. charcoal, graphite, activated carbon, or carbon black. The ore and the redox (reducing/oxidizing) agent are combined in the mill chamber in a weight ratio ranging from about 20:1 to about 1:1. Ore redox stoichiometry can be determined empirically for any given ore body and such empirically determined ore redox stoichiometry can be utilized to calculate optimum stoichiometric amounts of ore redox agents, which can be used alone or in combination.

In one example usage of the invention the reducing agent is a source of carbon and the ore is barite. The resultant product from such ore processing is concentrated in barium content.

In another example usage of the invention, iron ore including (ferric) iron oxides and a carbon source are combined in an insulated mill chamber, with or without a catalyst, and the mill is operated to effect a reduction of at least a portion of the iron oxide components.

In yet another example usage of the invention, iron ore and an oxygen source are combined and reacted in an insulated mill, with or without a catalyst, to effect an oxidation of at least a portion of the iron oxide components.

In still another example usage of the invention iron ore and an oxygen source are combined and reacted in an insulated mill, with or without a catalyst to produce red iron oxide (pigment).

Also, hazardous organic compounds may be rendered non-hazardous (detoxified) by oxidizing them in the tribochemical process. The reactants can be optionally pre-processed to minimize tribochemical reaction times and improve conversion efficiency. Thus, for example, the reactant compositions can be pre-milled to a predetermined particle size in a classical milling apparatus prior to loading into the insulated mill. The reactants can also be preheated and/or dried to reduce their water content, and thus their conductivity, to a predetermined level before they are loaded into the insulated mill for tribochemical processing. Interference of atmospheric oxygen with the tribochemical reactions can be minimized by purging the mill with an inert gas prior to and/or during mill operation.

In another example usage of the present invention, the solid reactants in the mill are components of a mineral glass produced from plasma fusion processing of a mineral ore containing platinum, palladium, iridium, rhodium, osmium, gold, silver, and ruthenium. Typically the ore mineral contains varying amounts of more than one of such precious metal species. In one aspect of this invention, the ore mineral is first processed by heating it in a deep carbon crucible using an argon plasma power supply with tungsten electrodes to temperatures between about 3,500° and 8,000° F. The resulting mineral glass formed by the cooling of the plasma-fused mineral ore can be delivered to a mill such as a ball mill, a bar mill, or a swing mill that is modified in accordance with this invention and milled. During the milling process the surfaces of the milling elements are impregnated and coated with one or more of the precious metal species in the ore.

The precious metal species is thereafter recovered from the surfaces of the milling elements by mechanical or chemical processing. Thus, for example, when the milling elements are steel or steel alloy balls, the precious metal species can be harvested chemically using art-recognized metal dissolving chemistry. Alternatively, the metal coated/impregnated milling balls can be heated to a temperature of about 300° to 1000° F. in air or oxygen to oxidize and vaporize the osmium component as osmium tetroxide, which can then be condensed and separated from the other precious metals. The heated milling elements are then quenched in a water bath to delaminate the outer coated/impregnated surface of the milling balls. The resulting delaminated metal/metal oxide flakes are collected, digested with a concentrated mineral acid solution (with optional heating), and then collected as in filtration or centrifugation to provide a product concentrated in the precious metal species. The product can then be processed by art-recognized metal reclamation techniques to separate the product into its precious metal components. The processed milling balls can then be washed/neutralized and reused in the tribochemical process. When the milling elements used to mill the plasma-fused ore are in the form of steel bars, they can be processed as described above or the surfaces of the bars can be mechanically abraded to remove the milling surfaces impregnated or coated with the precious metal species. The product isolated from such mechanical processing is collected and sent to metal reclamation facilities for separating and concentrating the respective precious metal components.

Various uses of the present invention as stated previously are typically conducted at ambient temperature, however, higher temperatures can be employed using milling devices modified with heating elements in accordance with this invention. At ambient temperature, the present tribochemical processes are usually complete in less than 12 hours but more typically in less than 4 hours of mill operation. The processing time and milling parameters can be optimized by empirical evaluation of reaction efficiencies at various times and temperatures.

The present invention is further illustrated by the following examples which are not intended to limit the invention, but instead to depict its broad application.

### EXAMPLES

### Example 1

### Barite Ore Processing

Twenty-two lbs. of steel balls having a diameter of about 1 inch, 200 g of barite ore and 60 g of carbon were loaded into a 12″×12″ neoprene lined steel mill similar to that illustrated in FIG. 1. The mill chamber was purged with argon for two minutes and sealed. The mill was operated at 60 rpm for three hours. The milling elements were separated from the mill reacted ore product, which was found to be about 2% by weight ferromagnetic (adheres to magnet). The mass of the product mixture retrieved from the ball mill after the milling process was 210 g. That material was washed in 500 ml of heated (about 170° F.) distilled water for 30 minutes. The mixture was then filtered and the pH of the filtrate was adjusted with sodium carbonate to pH 6.5 to effect precipitation of the soluble barium species as barium carbonate.

### Example 2

### Processing of Iron Ore to Soft Iron Ferrite or Raw Material for the Manufacture of Iron, Steel or Steel Alloys

(A) A 100-gallon Abbe Pebble Mill was charged with 200 lbs of steel balls, 21.25 lbs of iron ore, and 3.75 lbs of charcoal. The mill chamber was purged with argon and operated at 51 rpm for 7.5 hours. Static charge buildup on the mill shell during the milling operation ranged from about 0.4 to about 2.6 v-AC/DC. The milled product was separated from the milling balls and found to be 56% by weight ferromagnetic.

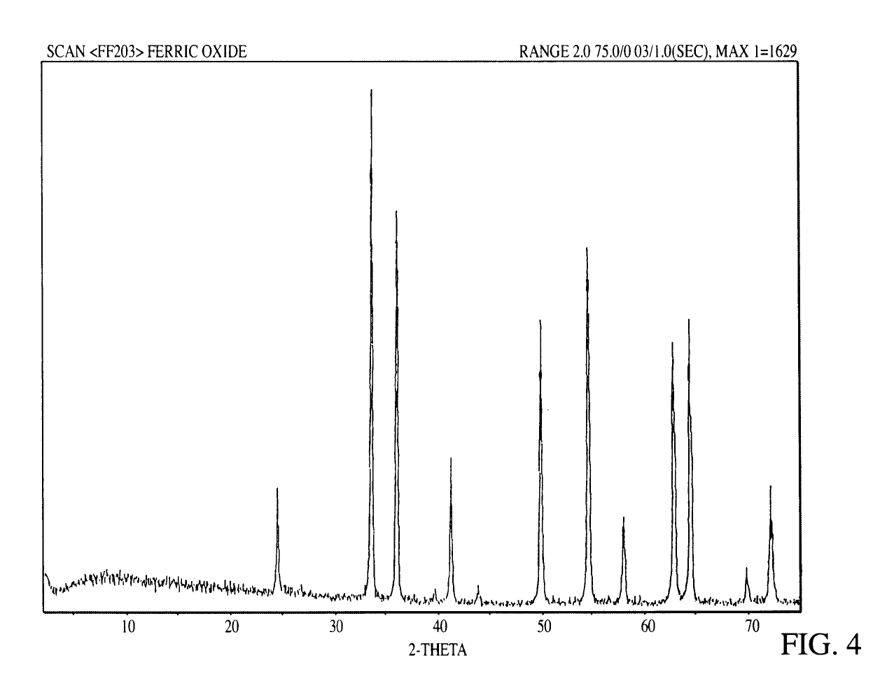

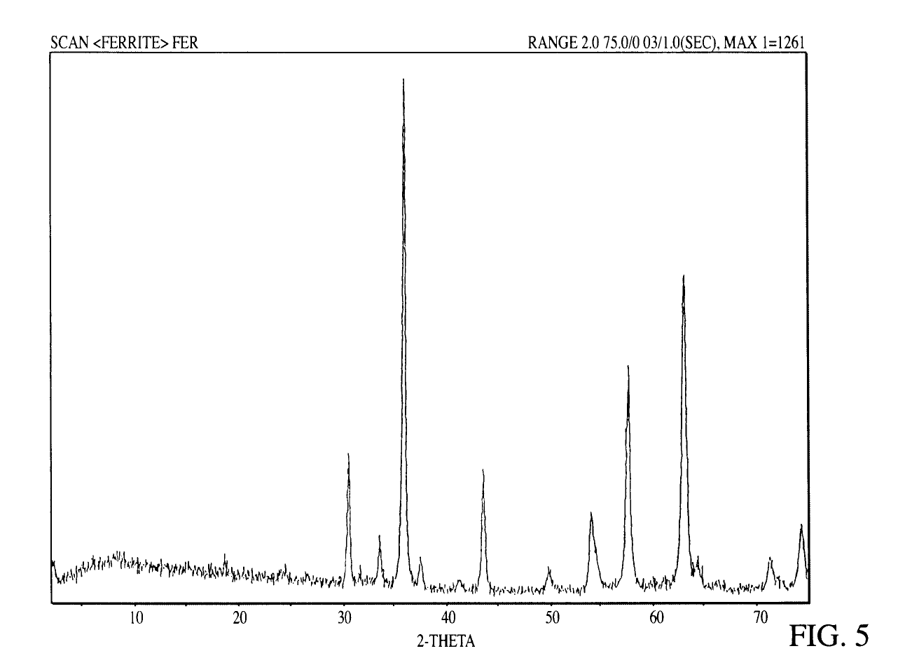

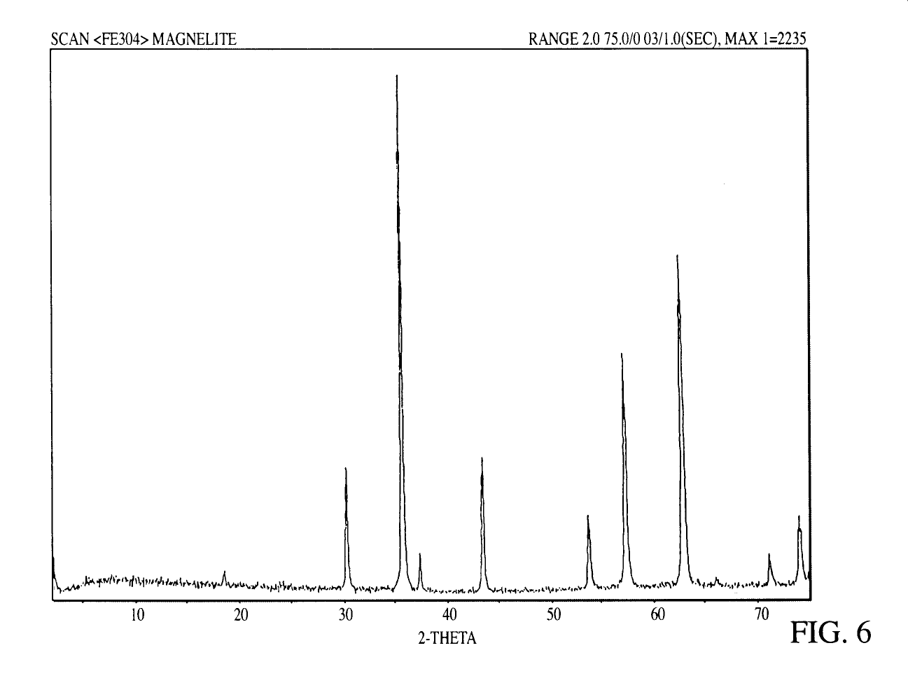

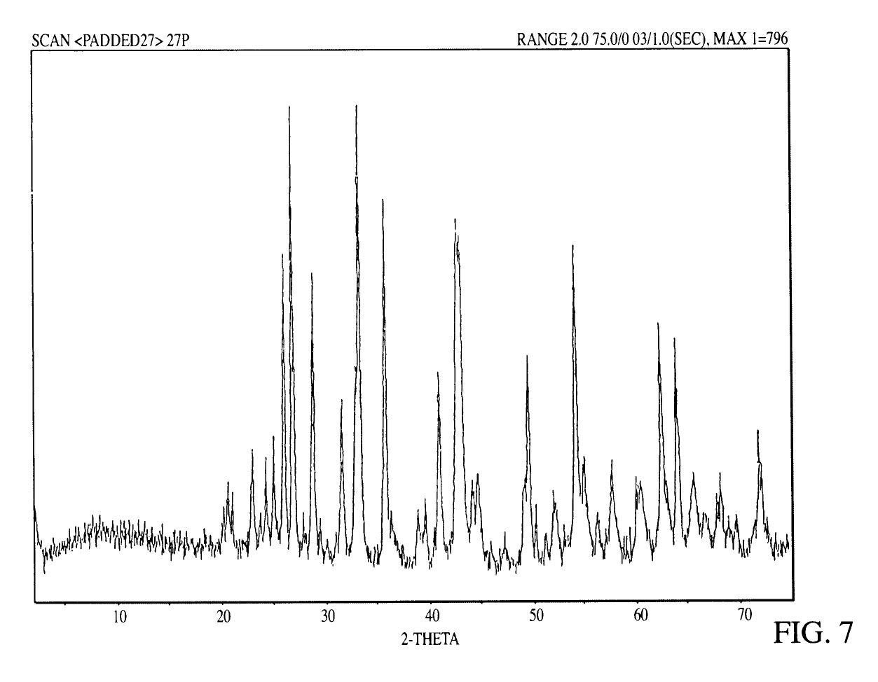

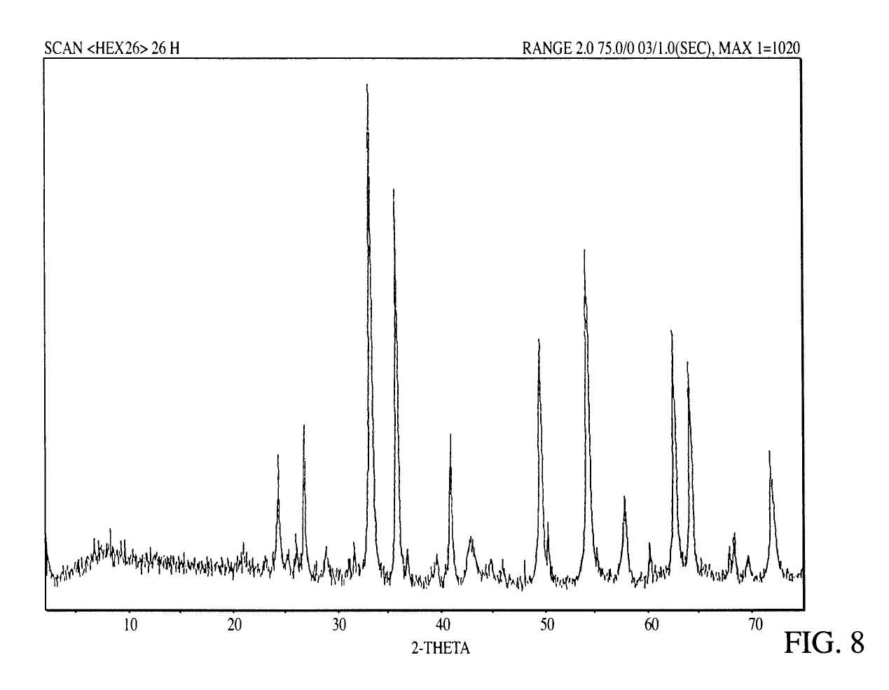

(B) Following a procedure similar to that set forth in paragraph (A) above, 300 g of iron ore and 34 g of carbon were introduced into two separate coated mills, one an internally dielectric-coated hexagonal mill and the other an internally dielectric-coated regular mill (having substantially uniform radius). Each mill was operated for four hours with about 10 kg of plated balls and rods. The magnetic portions of the products were separated and subjected to XRD analysis. The product produced by the hexagonal mill showed that the predominant species was still ferric oxide, however, new XRD peaks were observed. The XRD analysis of the product isolated from the internally padded (lined) regular mill demonstrated a greater conversion efficiency indicating multiple new peaks (reaction product species) in the product. See FIGS. 4-9 for comparison.

(C) The method of paragraph (A) above was repeated using 25 lbs each of iron ore and carbon, and the mill was operated at 24 rpm for 3.2 hours. The mill chamber included a throw bar element. Magnetic analysis of the resulting product showed it to be 7% by weight ferromagnetic. That same experiment was repeated again without argon purge of the mill chamber and with the mill being operated at 36 rpm for 3 hours. The product from that processing was shown to be 6% by weight ferromagnetic.

(D) The process described in paragraph (A) was repeated using 100 lbs of steel balls and 15 lbs of steel rods, with 12 lbs of iron ore and 3 lbs of carbon under an argon blanket. The mill was operated at 24 rpm for 4 hours and included an internal throw bar. Electrical measurements were made using an electrode in contact with the outer shell of the mill chamber during the mill operation. Frequency and voltage (AC and DC) were measured using a volt meter (an undampened Simpson meter) and a capacitor-coupled frequency counter. The detected frequency ranged from 1.0 to 21 MHz while the AC and DC voltages detected were 0.1 to 1.5 volts and 1.0 to 3.0 volts, respectively. Magnetic analysis of the product indicated 2.4 percent by weight of the product to be ferromagnetic. The experiment was repeated under the same conditions except that only rod milling elements (60 lbs) were used. Magnetic analysis of the product using the rod milling elements showed 6.6% conversion to ferromagnetic product.

(E) In still another experiment similar to that described in paragraph (A) above, 175 lbs of milling balls were combined with 12 lbs of iron ore and 25 g of manganese dioxide. Two milling runs were carried out at 24 rpm for 4 hours, one run using an argon atmosphere and another with air. Electrical measurements from the shell of the mill during mill operation as described in paragraph (D) above showed a frequency range of 1-12 MHz, a DC potential of 1-3 volts and an AC potential of 0.1-0.5 volts. Magnetic analysis of the respective products from the argon and air runs showed 20% and 98% conversion respectively to ferromagnetic materials.

F) In another experiment similar to paragraph (E) above, 68 lbs of milling balls and 32 lbs of milling rods were combined with 6 lbs of iron ore and 1 lb of carbon, with 10 g of manganese dioxide in a 100 gallon Abbe Pebble Mill. The mill was operated at 24 rpm for 4 hours. Electrical measurements during the run showed a frequency of 4-18 MHz, a DC potential of 0-0.1 volts and an AC potential ranging from 1.2 to 4.5 volts. Magnetic analysis of the product showed it to be 42 percent by weight ferromagnetic.

### Example 3

### Purification of Precious Metals

A sample of subsurface head ore from an ore body located in Northern Washoe County, Nevada was mined and assayed and found to contain varying amounts of gold, silver, platinum, palladium, iridium, rhodium, osmium, and ruthenium. A 10 oz. sample of the ore was introduced into a deep carbon crucible and delivered into an argon gas plasma chamber using tungsten electrodes operating at up to about 125 amps. The ore sample was heated in the plasma furnace to a temperature of about 3,500° to 8,000° F. The plasma-treated ore sample cooled to form a mineral glass/slag. The plasma-processed material was placed in a ball mill and ground to a powder and then placed in an insulated ball mill similar to that shown in FIG. 1 with 5 lbs of iron balls ranging in size from about 1 inch to 1 ¼ inch in diameter. The mill was run in 30 minute increments, after each of which the milling surfaces and the ground product were visually inspected. At the end of 4 hours all of the iron balls appeared to be plated with a hard lustrous surface alloy. There remained approximately 64 g of powder tailing dust in the mill that was found to be 100% ferromagnetic, possibly in some part due to the sloughing of iron from the milling elements. Preliminary calculations placed the thickness of the plating on the balls at approximately 0.015 inch. The test was repeated several times with run times ranging from 3 hours to 24 hours. It was concluded that virtually all metal deposition occurs within the first 3 hour period of mill operation. Independent analytical tests on the surface of one randomly selected milling ball showed the surface to be comprised of gold, silver, platinum, palladium, osmium, ruthenium, and iridium. Preliminary lab tests determined the presence of iron and palladium in the tailing dust. The test has been repeated on ore samples processed in a plasma hearth furnace with similar but less definitive results.

A portion of the plated iron balls was heated in a furnace to about 750° F. Effluent gas from the furnace was passed through a cooling tube to condense any volatilized metal/metal oxides, e.g. osmium tetroxide. The milling balls, still at about 750° F., were transferred to a water bath with resultant delamination of ‘flakes’ of metal/metal oxide from the surface of the balls. The flakes were washed, dried and forwarded for reclamation of the component precious metals.

It is understood that the invention is not confined to the particular construction and arrangement of parts herein illustrated and described, but embraces such modified forms thereof as come within the scope of the following claims.

What is claimed is:

1. A method for inducing a tribochemical reaction of chemical reactants, said method comprising the steps of combining said reactants in a mill, said mill comprising:
(a) an electrically insulated mill chamber for receiving said reactants said mill chamber having milling surfaces therein adapted for forceful abrasive or impact contact in the presence of said reactants during mill operation;
(b) said mill chamber having inner walls comprising a dielectric coating; and
(c) operating said mill for a period of time sufficient to effect at least a partial chemical reaction of the reactants.

2. The method of claim 1 wherein the tribochemical reaction comprises at least one redox reaction.

3. The method of claim 2 wherein the oxidizing agent is oxygen.

4. The method of claim 2 wherein the reducing agent is carbon.

5. The method of claim 4 wherein the carbon is present as a gas, charcoal, graphite, activated carbon, carbon black or compositions thereof.

6. The method of claim 1 wherein the reactants comprise at least one solid reactant and a gas capable of reacting with said solid reactants during mill operation.

7. The method of claim 1 wherein the reactants in said mill chamber are maintained in an inert atmosphere during operation of the mill.

8. The method of claim 7 wherein the inert atmosphere results from purging the mill chamber with a gas selected from the group comprising: helium, neon, argon, xenon, radon, krypton and compositions thereof.

9. The method of claim 1 wherein the reactants are iron ore, a source of oxygen and a catalyst and the product is a partial oxidation of the ore to iron (ferric) oxide, Fe₂O₃.

10. The method of claim 9 wherein the catalyst is manganese dioxide.

11. The method of claim 1 wherein the contents of the chamber comprise iron ore and carbon and the products of the reaction are an iron-carbon alloy or carbon steel raw material.

12. The method of claim 1 wherein the solid reactants comprise components of a mineral glass produced from plasma fusion of a mineral ore comprising a compound of precious metals selected from the group consisting of platinum, palladium, iridium, rhodium, osmium, gold, silver, ruthenium and compositions thereof.

13. The method of claim 12 wherein the milling surfaces become impregnated with one or more of the precious metal species.

14. The method of claim 13 wherein the precious metal species are recovered from the surfaces of the milling elements by mechanical or chemical processing.

15. The method of claim 1 wherein the milling surfaces are selected from the group consisting of iron, nickel, cobalt, alloys thereof, boron carbide, aluminum oxide, silicon carbide, silicon nitride, aluminum nitride, titanium carbide, titanium nitride, tungsten carbide, tantalum nitride and zircon ceramic and compositions thereof.

16. The method of claim 15 wherein the milling surfaces are in the form of balls or rods.

17. The method of claim 1 wherein the mill is a ball mill, rod mill or a swing mill.

18. The method of claim 1 wherein the reactants include a substantially water insoluble ore comprising:
(a) a metal species;
(b) an ore reducing agent; and
(c) wherein during mill operation at least a portion of the water insoluble ore is converted to a water soluble form of said metal species.

19. The method of claim 18 further comprising the step of washing the milled reactants to form a solution of water soluble metal salts therein and processing said solution to produce a resultant product concentrated in one or more of the metal species.

20. The method of claim 18 wherein the reactants in the chamber comprise iron ore and an element from the group consisting of nickel molybdenum, aluminum, zinc, copper, gold, chromium, indium, lead, tin, silver, cadmium, titanium, tungsten, ruthenium and compositions thereof and the product of the reaction is an iron alloy of said element.

21. The method of claim 18 wherein the milling surfaces are selected from the group consisting of iron, nickel, cobalt, alloys thereof, boron carbide, aluminum oxide, silicon carbide, silicon nitride, aluminum nitride, titanium carbide, titanium nitride, tungsten carbide, tantalum nitride and zircon ceramic and compositions thereof.

22. The method of claim 21 wherein the milling surfaces are in the form of balls or rods.

23. The method of claim 18 wherein the ore reducing agent comprises an organic compound.

24. The method of claim 23 wherein the reducing agent is carbon and is present as a gas, charcoal, graphite, activated carbon, carbon black or compositions thereof.

25. The method of claim 23 wherein the reducing agent is a source of carbon, the ore is barite ore, and the resultant product is concentrated in barium content.

26. A method of detoxifying hazardous organic compounds by inducing a tribochemical reaction of chemical reactants, said method comprising the steps of combining said reactants in a mill, said mill comprising:
(a) an electrically insulated mill chamber for receiving said reactants, said mill chamber having surfaces therein adapted for forceful abrasive or impact contact in the presence of said reactants during mill operation;
(b) said mill chamber having inner walls comprising a dielectric coating; and
(c) operating said mill for a period of time sufficient to effect at least a partial chemical reaction of the reactants.

27. The method of claim 26 wherein said hazardous compounds can be pre-processed to minimize tribochemical reaction times.

28. The method of claim 26 wherein said reactants can be preheated or dried to reduce their water content thereby altering their conductivity.

29. A milling apparatus for facilitating tribochemical reactions between tribochemically reactive compositions being milled in said apparatus comprising:
(a) a mill chamber,
(i) said chamber having an outer shell and an inner surface comprising a dielectric composition,
(ii) said chamber containing a group of milling elements therein;
(b) a mounting frame for supporting the mill chamber for rotational, orbital or reciprocal movement relative to said mounting frame;
(c) a motor for delivering mechanical energy to move the mill chamber; and
(d) an insulating element positioned to electrically insulate the mill chamber above ground potential.

30. The apparatus of claim 29 wherein the milling apparatus is a ball mill, rod mill or swing mill.

31. The apparatus of claim 29 wherein the mill chamber is sealed to prevent material from flowing out of the chamber during milling operations, said milling apparatus further comprising a valved port for delivering or removing fluids from the chamber.

32. The apparatus of claim 29 further comprising a sensor for providing signals indicative of the temperature of the reactant compositions being milled in said apparatus.

33. The apparatus of claim 29 further comprising a heating element delivering thermal energy to compositions in the mill chamber and a controller for said heating element responsive to signals received from the temperature sensor.

34. The apparatus of claim 29 further comprising a means for measuring electrostatic charge on the outer shell of the mill during mill operation.

35. The apparatus of claim 29 further comprising a means for measuring the DC and AC voltage on the outer shell of the mill during mill operation.

36. The apparatus of claim 29 further comprising a means for measuring the frequency of the voltage on the outer shell of the mill during mill operation.
